(19) United States
(12) Patent Application Publication
(10) Pub. No.: US 2026/0188544 A1
(43) Pub. Date: Jul. 2, 2026

(54) SHUNT RESISTOR

(71) Applicant: KOA CORPORATION, Ina-shi, Nagano (JP)

(72) Inventors: Shuhei Matsubara, Ina-shi, Nagano (JP); Susumu Toyoda, Ina-shi, Nagano (JP); Koichi Hirasawa, Ina-shi, Nagano (JP); Keishi Nakamura, Ina-shi, Nagano (JP)

(73) Assignee: KOA CORPORATION, Ina-shi, Nagano (JP)

(21) Appl. No.: 19/130,304

(22) PCT Filed: Oct. 4, 2023
(86) PCT No.: PCT/JP2023/036174

§ 371 Date: May 15, 2025

(30) Foreign Application Priority Data
Nov. 22, 2022 (JP) 2022-186217

(51) Int. Cl. H01C 7/18; H01C 1/14

(52) U.S. Cl. CPC H01C 7/18; H01C 1/14

(57) ABSTRACT

The present invention relates to a shunt resistor. The shunt resistor (1) includes at least two elements (150) attached to an electrode member (10). The at least two elements (150) comprise resistance elements (5) having different resistivities.

### TECHNICAL FIELD

The present invention relates to a shunt resistor.

### BACKGROUND ART

There is a shunt resistor in which a current is passed through a resistance element and a magnitude of the current is detected from a voltage (potential difference) at both ends of the resistance element. Such a shunt resistor includes the resistance element and two electrodes is connected to the both ends of the resistance element.

### CITATION LIST

### Patent Literature

Patent document 1: Japanese laid-open patent publication No. 2018-536166

### SUMMARY OF INVENTION

### Technical Problem

In the shunt resistor, a low resistance value is set to reduce power loss due to resistance. For example, to detect a current of 40 A, a resistance value of 0.5 mΩ is used, and a potential difference across the resistor is about 20 mV. To detect the same potential difference, a resistance value of 50 μΩ is required when a current of 400 A flows. In this manner, a difference in the required resistance value when the current value to be detected is different is about 10 times different.

When measuring the current of 400 A, for example, a shunt resistor of 50 μΩ may be used, but depending on a circuit design, a required measurement range may be wider, such as when the same shunt resistor is required to detect a current of about 10 A. In this case, if a current of 10 A is measured with the shunt resistor with a resistance value of 50 μΩ, the potential difference is 0.5 mV, which makes it difficult to ensure the accuracy of current detection.

Thus, it is desirable to widen the range of the magnitude of the current to be measured (i.e., the measurement range) in the shunt resistor. However, in the above described shunt resistor, the measurement range is highly dependent on a resistivity (resistance value) of a single resistance element placed between two electrodes, so it is difficult to widen the measurement range. A shunt resistor in which the resistance elements are connected in series are known (see, for example, the patent document 1), but the patent document 1 does not disclose a configuration for widening the measurement range.

Therefore, the present invention provides a shunt resistor capable of widening the measurement range.

### Solution to Problem

In an embodiment, there is provided a shunt resistor comprising: an electrode member made of a conductive material; and at least two elements attached to the electrode member, the at least two elements comprise a resistance element having different resistivities.

In an embodiment, each of the at least two elements is a laminated element laminated in a thickness direction of the shunt resistor.

In an embodiment, the at least two elements as the laminated element have the same shape.

In an embodiment, each of the at least two elements are series elements arranged in a longitudinal direction of the shunt resistor.

In an embodiment, the resistance element comprises a sintered body disposed on one side and an alloy disposed on the other side.

In an embodiment, the sintered body has a resistivity of 450 μΩ cm or more.

In an embodiment, the alloy is composed of a CuM n-based alloy, and the sintered body is composed of a sintered body in which metal particles of NiCr, CuMn or CuNi are mixed with insulating particles such as alumina.

In an embodiment, the electrode member has a protruding portion formed in a central portion thereof.

### Advantageous Effects of Invention

The shunt resistor includes resistance elements having different resistivities (resistance values). By passing large and small currents through two types of resistance elements, magnitudes of the large and small currents can be measured. Therefore, the shunt resistor can widen the measurement range.

### BRIEF DESCRIPTION OF DRAWINGS

FIG. 1 is a perspective view showing one embodiment of a shunt resistor for current detection;

FIG. 2 is a longitudinal sectional view of the shunt resistor shown in FIG. 1;

FIG. 3 is a view showing another embodiment of the shunt resistor;

FIG. 4 is a view showing another embodiment of the shunt resistor;

FIG. 5 is a view showing another embodiment of the shunt resistor; and

FIG. 6 is a view showing another embodiment of the shunt resistor.

### DESCRIPTION OF EMBODIMENTS

Embodiments of the invention will be described below with reference to the drawings. In the drawings described below, identical or equivalent components will be marked with the same symbol to omit redundant explanations.

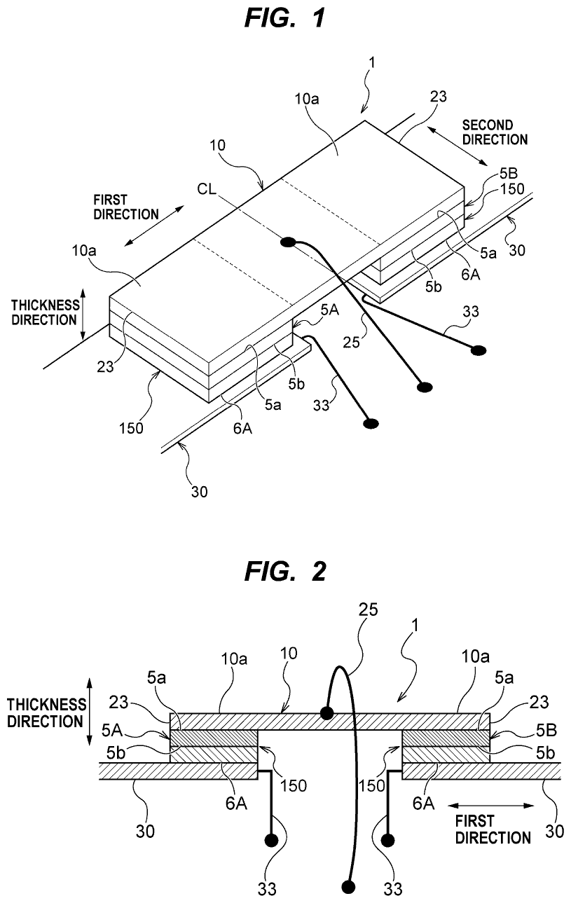

FIG. 1 is a perspective view showing one embodiment of a shunt resistor for current detection. FIG. 2 is a longitudinal sectional view of the shunt resistor shown in FIG. 1. As shown in FIGS. 1 and 2, a shunt resistor 1 includes an electrode member 10 made of a conductive material and at least two elements 150 attached to the electrode member 10.

In the embodiment shown in FIGS. 1 and 2, the shunt resistor 1 includes two elements 150, but may include three or more elements 150. The elements 150 have the same shape (structure). With such a structure, the elements 150 can have high durability (heat cycle, power cycle) and can improve their reliability. Furthermore, the shunt resistor 1 including the elements 150 having the same shape can have a high stress balance. The elements 150 having the same shape can be easily designed and can increase production efficiency.

Since the elements 150 have the same shape (structure), the following describes the structure of a single element 150. The element 150 includes a plate-shaped (thin plate-shaped) resistance element 5A (or resistance element 5B) having a predetermined thickness and width, and a plate-shaped (thin plate-shaped) electrode (first electrode) 6A made of a conductive material. The electrode 6A is disposed on an opposite side of the electrode member 10, sandwiching the resistance element 5A (or resistance element 5B) .

In the embodiment shown in FIGS. 1 and 2, each of the elements 150 is a laminated element laminated in a thickness direction of the shunt resistor 1. The thickness direction of the shunt resistor 1 is a direction parallel to the vertical direction. A first direction is a longitudinal direction of the shunt resistor 1. A second direction is a width direction of the shunt resistor 1, which is a direction perpendicular to the first direction.

The two resistance elements 5A and 5B provided in the shunt resistor 1 have different resistivities (resistance values). More specifically, one of the two resistance elements 5A and 5B is made of a material with a large resistance value (e.g., a sintered body), and the other is made of a material with a small resistance value (e.g., an alloy). Hereinafter, in this specification, the resistance elements 5A and 5B may be referred to as a resistance element 5 without any particular distinction.

In one embodiment, the sintered body as the resistance element 5 has a resistivity of 450 to 500 μΩ·cm. For example, the sintered body is made of NiCr—Al₂O₃, CuM n—Al₂O₃, CuNi—Al₂O₃, or the like, which is a sintered body in which metal particles of NiCr, CuM n, or CuNi are mixed with insulating particles such as alumina. In one embodiment, the alloy as the resistance element 5 has a resistivity of 44 μΩ·cm. For example, the alloy is made of a CuM n-based alloy or a CuM nNi-based alloy. The difference in resistivity between the two resistance elements 5A and 5B in this embodiment is about 10 times.

In the embodiment shown in FIGS. 1 and 2, the two resistance elements 5A and 5B have the same shape, so hereinafter, a single resistance element 5 will be described. The resistance element 5 has a first-resistance-element surface 5a and a second-resistance-element surface 5b which is a surface opposite to the first-resistance-element surface 5a. The electrode member 10 is connected to the first-resistance-element surface 5a, and the electrode 6A is connected to the second-resistance-element surface 5b. That is, the electrode 6A, the resistance element 5, and the electrode member 10 are layered in this order in the thickness direction of the shunt resistor 1.

The electrode member 10 has a contact portion 10a that come into contact with the elements 150. The number of the contact portions 10a corresponds to the number of the elements 150. In this embodiment, the shunt resistor 1 has two elements 150, and therefore the electrode member 10 has two contact portions 10a.

The two elements 150 are disposed symmetrically with respect to a center line CL of the electrode member 10, and are disposed in series with and spaced apart from each other in the first direction of the shunt resistor 1. The center line CL is an imaginary line segment that extends parallel to the second direction of the shunt resistor 1 and bisects the electrode member 10. The electrode member 10 has both end portions 23 in the first direction.

The electrode member 10 may be connected to the first-resistance-element surface 5a of the resistance element 5 by a connection means such as a conductive adhesive such as metal nanoparticles (silver paste using silver nanoparticles or copper paste using copper nanoparticles), welding such as pressure welding, or solder. The electrode 6A may also be connected to the second-resistance-element surface 5b of the resistance element 5 by a similar connection means. The electrode 6A is subjected to a surface treatment such as Sn plating or Ni plating to enable solder mounting. The surface plating of the electrode 6A may not be required.

The electrode member 10 has a structure that allows a temperature coefficient of resistance (TCR), which is an index showing a rate of change in resistance value due to temperature, to be adjusted by the thickness of the electrode member 10. More specifically, an accuracy of the TCR can be improved by adjusting the thickness of the electrode member 10. For example, the TCR can be reduced by reducing the thickness of the electrode member 10. In one embodiment, the electrode member 10 may have the same thickness as the resistance element 5, or may have a thickness thinner than the resistance element 5.

As shown in FIGS. 1 and 2, the shunt resistor 1 is mounted on a mounting land pattern. One end of a voltage detection wiring 25 is connected to a center of an upper surface of the electrode member 10, and the other end is connected to a connector (not shown). In one embodiment, the voltage detection wiring 25 may be a bonding wire. The upper surface of the electrode member 10 is subjected to a surface treatment (e.g., NiP plating, Ni plating, etc.) that allows a bonding wire to be connected. The shunt resistor 1 and the voltage detection wiring 25 connected to the upper surface of the electrode member 10 constitute a shunt resistance device.

The shunt resistor 1 is disposed on adjacent current-carrying patterns 30. The current-carrying pattern 30 is formed on a circuit board such as a printed circuit board (not shown). The element 150 (more specifically, the electrode 6A) is connected (joined) to the current-carrying patterns 30 by means of solder or the like.

Voltage detection wirings (lead wires) 33 are disposed between the current-carrying patterns 30. The voltage detection wiring 33 is a voltage detection terminal for detecting a potential difference occurring between the electrode member 10. The voltage detection wiring 25 is a wiring (terminal) for detecting a potential difference between the electrode member 10 and the voltage detection wiring 33.

The voltage detection wiring 25 is connected to the electrode member 10 of the shunt resistor 1, and the voltage detection wiring 33 is connected to the current-carrying pattern 30, forming a current path that flows from the current-carrying pattern 30 in the thickness direction of the shunt resistor 1. A voltage measuring device (not shown) is used to measure the potential difference (i.e., the potential difference in the resistance element 5) between the voltage detection wiring 25 and the voltage detection wiring 33. A current value is calculated by measuring this potential difference.

By passing a large current through the resistance element 5 having a small resistivity, it is possible to suppress heat generation from the resistance element 5, while by passing a small current through the resistance element 5 having a small resistivity, the potential difference becomes small. A small potential difference is difficult to measure.

According to this embodiment, it is possible to realize the shunt resistor 1 having a large difference in resistance value in one structure. More specifically, since the shunt resistor 1 includes the resistance elements 5 having different resistivities, it is possible to increase the potential difference by passing a small current through the resistance element 5 having a large resistivity, and as a result, the potential difference can be easily measured.

For example, as shown in FIG. 1, in a structure in which the resistance value of one resistance element 5 is 50 μΩ and the resistance value of the other resistance element 5 is 500 μΩ, the voltage detection wiring 25 is drawn from the electrode member 10 of the shunt resistor 1, and each voltage detection wiring 33 is drawn between the current-carrying patterns 30, when the resistance value of one resistance element 5 is 50 μΩ, a potential difference equivalent to 50 μΩ is obtained between one voltage detection wiring 33 and the voltage detection wiring 25. When the resistance value of the other resistance element 5 is 500 μΩ, a potential difference equivalent to 500 μΩ is obtained between the voltage detection wiring 25 and the other voltage detection wiring 33.

When detecting a current of 400 A level, the detection wiring between the low resistance values is used, and when detecting a current of 10 A level, the detection wiring between the high resistance values is used. With this configuration, detection can be performed over a wide current range. In this case, the difference in resistance between the two resistors 5A and 5B is 10 times.

Furthermore, when the shunt resistor 1 including the resistance element 5 having such a resistance value is used and a current of 400 A is loaded, the resistance element 5 having a resistance value of 50 μΩ generates 8 W of heat, and the resistance element 5 having a resistance value of 500 μΩ generates 80 W of heat.

The resistance element 5, which generates heat of 80 W, becomes very hot and therefore needs to dissipate the heat efficiently. In this embodiment, the entire surface of the element 150, which is a plate-shaped laminated element, is connected to the current-carrying pattern 30 via the electrode 6A, so that a contact area of the electrode 6A with the current-carrying pattern 30 can be increased. Therefore, the shunt resistor 1 can dissipate heat from the resistance element 5 via the current-carrying pattern 30.

In the embodiment described above, the elements 150 have the same shape, but in one embodiment, the elements 150 may have different shapes. In one embodiment, the size of the resistance element 5 of the element 150 is increased, thereby improving the heat dissipation of the resistance element 5.

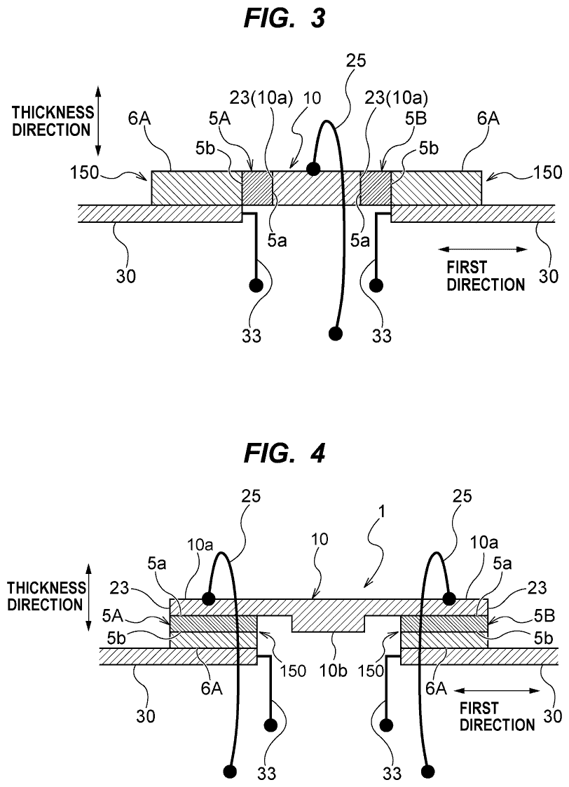

FIG. 3 is a view showing another embodiment of the shunt resistor. In the embodiment shown in FIG. 3, the elements 150 are series elements arranged in the longitudinal direction of the shunt resistor 1. As shown in FIG. 3, the electrode 6A, the resistance element 5, and the electrode member 10 are arranged in this order in the longitudinal direction of the shunt resistor 1. In the embodiment shown in FIG. 3, the both end portions 23 of the electrode member 10 correspond to two contact portions 10a.

FIG. 4 is a view showing another embodiment of the shunt resistor. In the embodiment shown in FIG. 4, the electrode member 10 has a protruding portion 10b formed in the central portion thereof. The protruding portion 10b is disposed between the elements 150 and 150 serving as the laminated element. By forming the protruding portion 10b, heat from the resistance element 5 can be dissipated more efficiently.

As shown in FIG. 4, the number of the voltage detection wires 25 corresponds to the number of the elements 150. Therefore, the shunt resistance device includes at least two voltage detection wires 25 connected to at least two contact portions 10a. The two voltage detection wires 25 are arranged on the both end portions 23 of the electrode member 10.

The TCR can be adjusted by adjusting the positions (bonding positions) of the two voltage detection wires 25. More specifically, the TCR decreases when the two voltage detection wires 25 are disposed on the both end portions 23 side, and the TCR increases when the two voltage detection wires 25 are disposed on a central portion side of the electrode member 10.

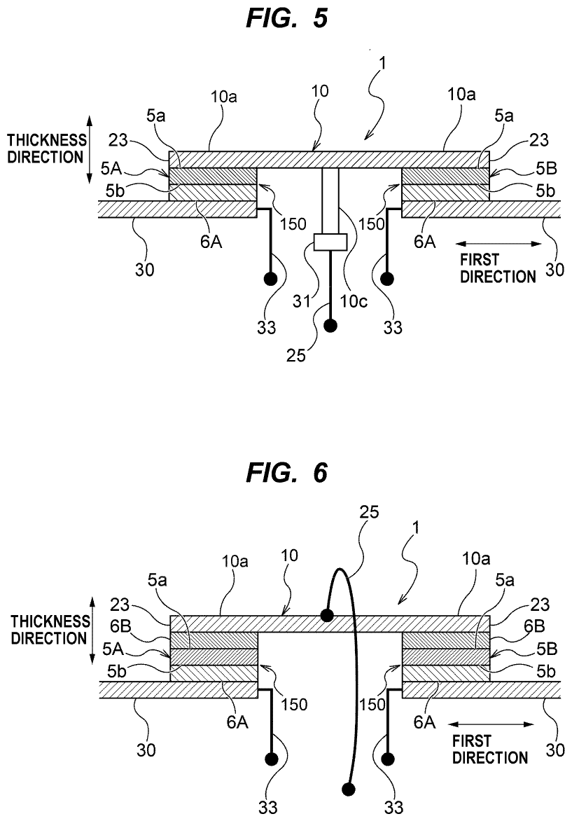

FIG. 5 is a view showing another embodiment of the shunt resistor. In the embodiment shown in FIG. 5, the shunt resistance device includes a jumper terminal 10c extending from the central portion of the electrode member 10 instead of the voltage detection wiring 25. The jumper terminal 10c is an integrally molded member with the electrode member 10, and is connected to the current-carrying pattern 31. In this embodiment, the jumper terminal 10c extends from a lower surface of the electrode member 10.

FIG. 6 is a view showing another embodiment of the shunt resistor. In the embodiment shown in FIG. 6, the element 150 as the laminated element may include an electrode (second electrode) 6B disposed between the resistance element 5 and the electrode member 10.

The above embodiments are described for the purpose of practicing the present invention by a person with ordinary skill in the art to which the invention pertains. Although preferred embodiments have been described in detail above, it should be understood that the present invention is not limited to the illustrated embodiments, but many changes and modifications can be made therein without departing from the appended claims.

### INDUSTRIAL APPLICABILITY

The present invention is applicable to a shunt resistor.

### REFERENCE SIGNS LIST

1 shunt resistor
5 (5A, 5B) resistance element
5a first-resistance-element surface
5b second-resistance-element surface
6A first electrode
6B second electrode
10 electrode member
10a contact portion
10b protruding portion
10c jumper terminal
23 both end portion
25 voltage detection wiring
30 current-carrying pattern
31 current-carrying pattern
33 voltage detection wiring
150 element
CL center line

1. A shunt resistor comprising:
an electrode member made of a conductive material; and
at least two elements attached to the electrode member,
wherein the at least two elements comprise a resistance element having different resistivities.

2. The shunt resistor according to claim 1, wherein each of the at least two elements is a laminated element laminated in a thickness direction of the shunt resistor.

3. The shunt resistor according to claim 2, wherein the at least two elements as the laminated element have the same shape.

4. The shunt resistor according to claim 1, wherein each of the at least two elements are series elements arranged in a longitudinal direction of the shunt resistor.

5. The shunt resistor according to claim 1, wherein the resistance element comprises a sintered body disposed on one side and an alloy disposed on the other side.

6. The shunt resistor according to claim 5, wherein the sintered body has a resistivity of 450 μΩ cm or more.

7. The shunt resistor according to claim 5, wherein the alloy is composed of a CuMn-based alloy, and
wherein the sintered body is composed of a sintered body in which metal particles of NiCr, CuMn or CuNi are mixed with insulating particles such as alumina.

8. The shunt resistor according to claim 1, wherein the electrode member has a protruding portion formed in a central portion thereof.
